(19) United States
(12) Patent Application Publication
(10) Pub. No.: US 2022/0011428 A1
(43) Pub. Date: Jan. 13, 2022

(54) FISH FINDING DEVICES, SYSTEMS AND METHODS

(71) Applicant: Nigel Brandon, Phoenix, AZ (US)

(72) Inventor: Nigel Brandon, Phoenix, AZ (US)

(21) Appl. No.: 16/926,921

(22) Filed: Jul. 13, 2020

(51) Int. Cl. G01S 15/96; G01S 7/00; G01S 7/524; G01S 7/526

(52) U.S. Cl. CPC G01S 15/96; G01S 7/526; G01S 7/524; G01S 7/003

(57) ABSTRACT

Fish finding devices, systems and methods, in accordance with the present disclosure comprise a sonar transmitter for transmitting a sonar signal, a sonar receiver for receiving a sonar echo from the reflection of the sonar signal off a marine animal, an underwater camera, a processor for controlling the sonar transmitter, the sonar receiver and the underwater camera, and for processing the sonar echo, and a housing containing the processor and further comprising a display. By combining the forgoing into a single fish finding system, “false positives” are reduced and have the capability of more accurately identifying desired marine animals that are located.

### FIELD OF THE INVENTION

The invention relates to the field of underwater fish finding devices, systems and methods.

### BACKGROUND

A variety of fish finding technology for locating fish in bodies of both salt and fresh water exist. For example, many fish finders use sonar (Sound Navigation and Ranging) systems to locate fish, both recreationally and commercially. Such fish finders may have a broad area of coverage and can display the location of a fish on a screen such as an LCD screen. While fish finder technology has developed to become more sophisticated, including GPS (Global Positioning System), compasses, weather technology and other features, existing devices often display “false positives” and are not able to consistently identify the type of fish (or other marine animal) that is located. Thus, a device that is able to couple the broad range of existing and new fish finders with the capability of more accurately identifying the fish located is desirable.

### SUMMARY OF THE INVENTION

The present disclosure contemplates fish finding devices, systems and methods. For example, in accordance with the present disclosure, a fish finding system comprises a sonar transmitter for transmitting a sonar signal, a sonar receiver for receiving a sonar echo from the reflection of the sonar signal off a marine animal or other underwater item, an underwater camera, a processor for controlling the sonar transmitter, the sonar receiver and the underwater camera, and for processing the sonar echo, and a housing containing the processor and further comprising a display. By combining the forgoing into a single fish finding system, “false positives” are reduced and have the capability of more accurately identifying desired marine animals that are located.

### BRIEF DESCRIPTION OF THE DRAWINGS

The accompanying drawings provide a further understanding of the invention and are incorporated in and constitute a part of this specification, illustrate embodiments of the invention, and together with the description serve to explain the principles of the invention.

FIG. 1 is a view of a fish finding system in use in accordance with the present disclosure; and

FIG. 2 is a view of the display of a fish finding system in use in accordance with the present disclosure.

### DETAILED DESCRIPTION OF THE ILLUSTRATED EMBODIMENTS

Persons skilled in the art will readily appreciate that various aspects of the present invention may be realized by any number of methods and apparatuses configured to perform the intended functions. Stated differently, other methods and apparatuses may be incorporated herein to perform the intended functions. It should also be noted that the accompanying drawing figures referred to herein are not all drawn to scale, but may be exaggerated to illustrate various aspects of the present invention, and in that regard, the drawing figures should not be construed as limiting. Finally, although the present invention may be described in connection with various principles and beliefs, the present invention should not be bound by theory.

The above being noted, in accordance with the present disclosure, a fish finding system comprises a sonar transmitter for transmitting a sonar signal, a sonar receiver for receiving a sonar echo from the reflection of the sonar signal off a marine animal or other item, alive or inanimate, an underwater camera, a processor for controlling the sonar transmitter, the sonar receiver and the underwater camera, and for processing the sonar echo, and a housing containing the processor and further comprising a display.

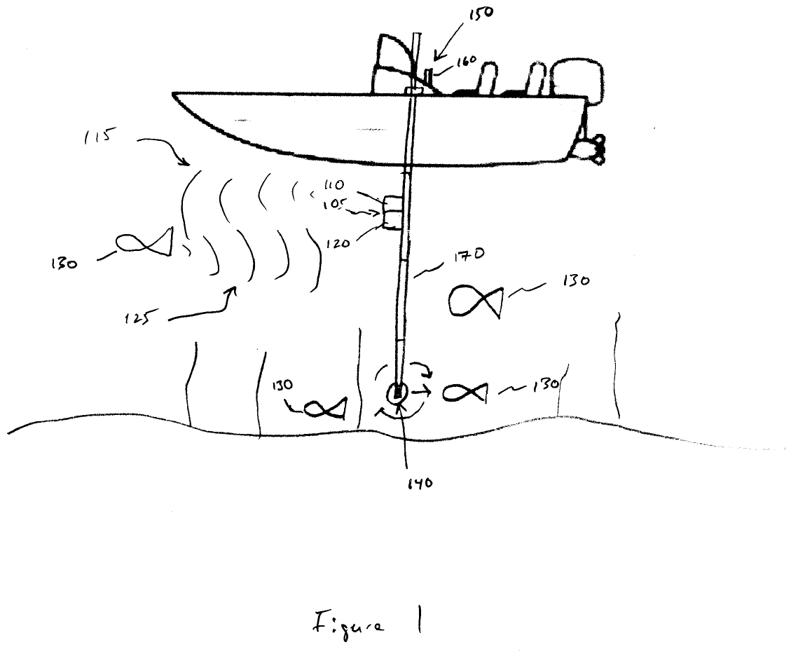

For example, with reference to FIG. 1, a fish finding system in accordance with the present disclosure includes a sonar transmitter 110 for transmitting a sonar signal 115 and a sonar receiver 120 for receiving a sonar echo 125 from the reflection of the sonar signal 115 off a marine animal 130 or other underwater item. The fish finding system may be built in or otherwise incorporated into a boat or vessel, or may be retrofit to the boat or vessel. The marine animal 130 can be any living aquatic animal, in fresh water or the ocean or seas, including fish, crustaceans, mammals, reptiles or the like. Any conventional sonar system, now known or as yet unknown, that uses sonar transmitters and receivers to send and receive sonar echoes are contemplated herein. In accordance with various aspects, the sonar transmitter 110 and sonar receiver 120 may be contained in a single sonar unit 105 or may each be individual units. Either or both of the sonar transmitter 110 and the sonar receiver 120 may be underwater during use.

In accordance with the present disclosure, a fish finding system further includes an underwater camera 140. The underwater camera 140 is any camera suitable for use underwater at varying depths. The camera 140 may take still images and/or video. In accordance with various aspects, the camera 140 may be high definition or standard definition, and may have zoom capabilities, low light capabilities (e.g., infrared) and other features known or as yet unknown. In various embodiments, a supplemental light may be provided to enhance visibility by the camera 140.

In accordance with the present disclosure, a fish finding system further includes a processor for controlling the sonar transmitter 110, the sonar receiver 120, and various aspects of the underwater camera 140 are described herein. Additionally, the processor processes the sonar echo 125 as described in further detail herein.

In accordance with the present disclosure, a fish finding system further includes a housing 150 for containing the processor, a power supply or power connection, a display 160, as well as other components such storage media (e.g., SSD, HDD, etc.), wired and wireless connectivity components (e.g., ethernet, Wi-Fi, Bluetooth, etc.). The housing 150 is typically above the waterline, often mounted near other controls on a boat.

In order to make sure the sonar echoes 125 received are not false positives, the sonar echoes 125 received after reflecting off the underwater items are processed via the processor using algorithms based on predetermined size, movement, shape and the like, and information is displayed on the display differently compared to those coming from inanimate objects such as rocks, tree branches, and sand bars. Additionally, the processor may distinguish the size of the marine animal 130, a pre-determined distance of the marine animal 130 from the sonar unit.

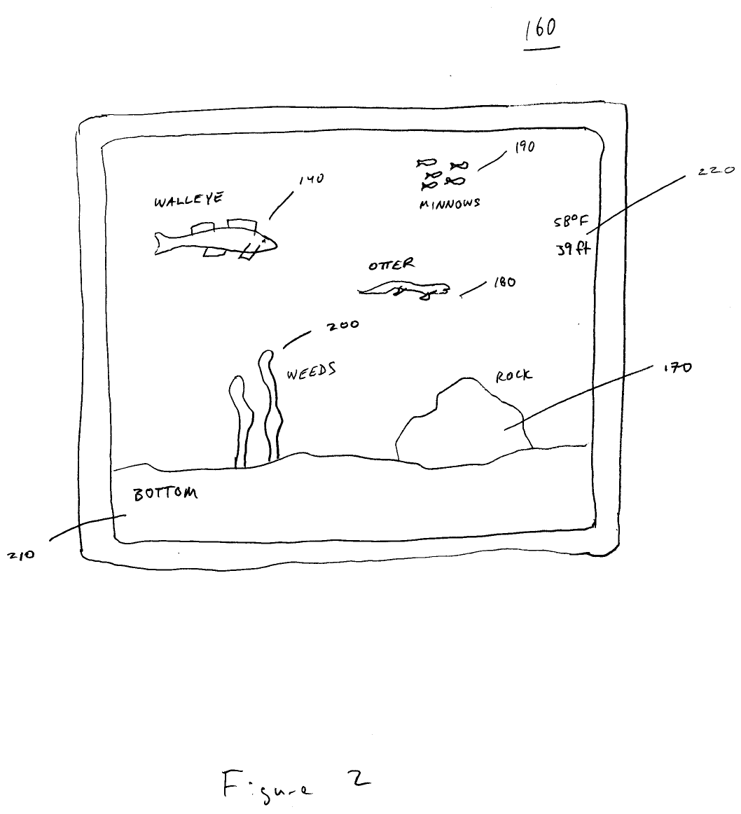

Additionally, the processor may be capable of filtering a specific type of marine animal 130 based on the difference of aspects of the sonar echo 125 such as the frequency, strength 34, and duration of the sonar echo 125. After such processing, the sonar echo 125 is converted to a symbol on display 160. By such filtering, the sonar echoes 125 of small size fish or schools of the same, other marine animals or other items can be marked, noted or even deleted from the display 160, with only the desired marine animal 130 shown one the display 160. For example, the processor may be configured to recognize a fish compared to an otter, or even down to species such as a walleye compared to a bluegill. With reference to FIG. 2, the display 160 can display a graphical symbol of the item. The symbols may be different for items other than the desired marine animal 130.

As noted above, a fish finding system in accordance with the present disclosure includes a camera 140 that is controlled by the processor. The camera 140 is maintained underwater at a desired depth, which may be adjustable. For example, the camera 140 may be attached to a tether 170 which may be a flexible tube or hose that can be reeled up and down to a desired depth. Alternatively, the camera 140 may be mounted on a telescoping pole that can be adjusted to a desired depth. In accordance with some aspects, the processor can automatically control the depth of the camera 140 on the tether 140, for example, by actuating a motor to raise and lower the cameral 140. Additionally, in the case of a telescoping, suitably rigid tether 140, the camera may be rotated up to 360° as well. Further still, the angle of the camera 140 may be oriented up or down as well, by for example, a camera motor. Further still, the aperture and zoom of the camera 140 may also be controlled. Any or all of these camera 140 positions and settings may be controlled by the processor and/or the user.

In operation, in accordance with various aspects of the present disclosure, upon processing a sonar echo 125 and determining the presence of a desired marine animal 130 such as a fish of pre-determined size and/or species, the processor causes the underwater camera 140 to turn towards the marine animal 140 and an image of the marine animal 140 can be displayed on the display 160. The image may be a still image or video, either or both of which may be recorded on a storage medium for later review.

In accordance with various aspects of the present disclosure, the display 160 is capable of displaying both live video and images from the underwater camera 140 as well as displaying additional information (e.g., depth, water temperature, etc.), a graphical “cross-section” from the surface of the water to bottom, with symbols (e.g., fish, weeds, rocks, etc.), words (e.g. “fish,” “rock,” etc.), and/or overlaying the live image with similar symbols and words, as well as other information. For example, with continuing reference for example to FIG. 2, a live video image from the camera 140 is shown on the display 160. The processor can use either or both of the video and the sonar echoes 125 to determine an expected species of the marine animal 140 and presents the expected species on the display 160.

For example, upon encountering a fish meeting criteria making the a walleye the likely species encountered, the display 160 may display “WALLEYE” adjacent the image of the marine animal 140. Alternatively (or in addition to) the processor may also cause a symbol of a fish (or other desired symbol) to be displayed in the vicinity of the image. A user may be able to toggle between different live views and graphical representations. The processor may further allow identification of other animals or inanimate objects, and again, the images may be displayed on display 160 or graphically represented through words and/or symbols. For example, the processor may identify a rock 170, an otter 180, a school of minnows 190, weeds 200, the bottom 210 and any number of other items based on the sonar echo 125 from the different items and may further compare the images from the camera 140 to the sonar echoes 125 to verify and analyze the item. Further still, other information 220 that may be useful to a user of the fish finding system, such as temperature, depth and the like may be displayed on display 160.

In accordance with various aspects of the present disclosure, the fish finding system may have various mechanisms for alerting a user when a predetermined parameter is met. For example, such parameters may include a type and/or size of fish, the distance to the fish, as well as the presence of other items such as shallow bottom, rocks, weeds and the like. Alerts may be audible such as chime or tone and/or visual such as a flashing light on the display 160 or on the housing 150 itself.

It will be apparent to those skilled in the art that various modifications and variations can be made in the present invention without departing from the spirit or scope of the invention. For example, numerous materials, shapes, sizes and configurations can be substituted in place of those described herein. Thus, the present invention covers the modifications and variations of this invention provided they come within the scope of the appended claims and their equivalents.

What is claimed:

1. A fish finding device comprising:
a sonar transmitter for transmitting a sonar signal,
a sonar receiver for receiving a sonar echo from a reflection of the sonar signal off a marine animal;
an underwater camera;
a processor for controlling the sonar transmitter, the sonar receiver and the underwater camera, and for processing the sonar echo; and
a housing containing the processor and further comprising a display.

2. The fish finding device of claim 1, wherein the sonar transmitter and the sonar receiver are contained in a single sonar unit.

3. The fish finding device of claim 2, wherein the single sonar unit is underwater.

4. The fish finding device of claim 2, wherein the processor distinguishes a size of the marine animal, a pre-determined distance of marine animal from the sonar transmitter, and alerts a user when the pre-determined distance is within a pre-selected value or when the marine animal meets a predetermined size.

5. The fish finding device of claim 1, wherein the processor controls at least one of a depth, a rotation, an angle and a zoom of the underwater camera.

6. The fish finding device of claim 1, wherein upon processing the sonar echo and determining a presence of the marine animal, the processor causes the underwater camera to turn towards the marine animal.

7. The fish finding device of claim 6, wherein the processor determines an expected species of the marine animal and presents the expected species on the display.

8. The fish finding device of claim 6, wherein an image of the marine animal is presented on the display.

9. The fish finding device of claim 6, wherein the processor determines an expected species of the marine animal and presents the expected species on an over lay of an image of the marine animal presented on the display.

10. The fish finding device of claim 1, wherein an image of the marine animal is recorded to a storage medium.

11. The fish finding device of claim 1, wherein the processor distinguishes sonar echoes from marine animals and inanimate objects.
